(19) United States
(12) Patent Application Publication
(10) Pub. No.: US 2022/0056977 A1
(43) Pub. Date: Feb. 24, 2022

(54) SYSTEM CENTER/INNER TUBE WITH O-RING SEAL

(71) Applicants: ThyssenKrupp Bilstein GmbH, Ennepetal (DE); thyssenkrupp AG, Essen (DE)

(72) Inventors: Christoph Steger, Essen (DE); Klaus Schmidt, Odenthal (DE)

(73) Assignees: ThyssenKrupp Bilstein GmbH, Ennepetal (DE); thyssenkrupp AG, Essen (DE)

(21) Appl. No.: 17/406,037

(22) Filed: Aug. 18, 2021

(30) Foreign Application Priority Data
Aug. 19, 2020 (DE) 10 2020 210 540.5

(51) Int. Cl. F16F 9/36; F16F 9/32

(52) U.S. Cl. CPC F16F 9/368; F16F 9/364; F16F 9/3235; F16F 9/3228

(57) ABSTRACT

A vibration damper for a vehicle may include an outer tube, a middle tube, and an inner tube arranged coaxially. The inner tube is at least partially filled with damping medium, and a piston rod is arranged in the inner tube so as to be movable to and fro. A working piston arranged on the piston rod is movable with the piston rod. An inner chamber of the inner tube is divided by the working piston into a rod-side working chamber and a rod-remote working chamber, with a connecting element being arranged between the inner tube and the middle tube on each side of a middle tube opening facing tube ends of the middle tube. The connecting element may include a radially circumferential sealing element that seals a middle tube balancing chamber against an outer tube balancing chamber at least with respect to the damping medium.

### CROSS REFERENCE TO RELATED APPLICATIONS

This application is a U.S. Nonprovisional Application that claims priority to German Patent Application No. DE 10 2020 210 540.5, filed Aug. 19, 2020, the entire contents of which are incorporated herein by reference.

### FIELD

The present disclosure generally concerns vibration dampers, including middle tubes for vibration dampers.

### BACKGROUND

Vibration dampers, in particular multi-tube dampers for motor vehicles, are known in the prior art in a multiplicity of embodiments. It is however problematic to provide vibration dampers, in particular multi-tube vibration dampers for motor vehicles, and middle tubes for vibration dampers of motor vehicles, which can be assembled simply and quickly and be produced economically, and which also fulfil or exceed the requirements for safety, operability, durability and strength.

Thus a need exists for an improved vibration damper, in particular a multi-tube vibration damper, and an improved middle tube, with which the above-mentioned disadvantages are avoided. In particular, a need exists for an improved vibration damper, in particular a multi-tube vibration damper, and an improved middle tube that allow for a simple, in particular modular, and economic design. Also, a need exists for improved ease of assembly, in particular production of the vibration damper.

### BRIEF DESCRIPTION OF THE DRAWINGS

FIG. 1 is a longitudinal sectional view of an example vibration damper.

FIG. 2 is a longitudinal sectional view of a vibration damper in a region of the damper tubes.

FIG. 3 is a longitudinal sectional view of a vibration damper in a region of a seal of an inner tube against a middle tube.

FIG. 4 is a longitudinal sectional view of a vibration damper in a region of a seal of an inner tube against a middle tube.

FIG. 5 is a longitudinal sectional view of another example vibration damper in a region of a seal of an inner tube against a middle tube.

FIG. 6 is a longitudinal sectional view of still another example vibration damper in a region of a seal of an inner tube against a middle tube.

FIG. 7 is a longitudinal sectional view of a further example vibration damper in a region of a seal of an inner tube against a middle tube.

FIG. 8 is a longitudinal sectional view of yet a further example vibration damper in a region of a seal of an inner tube against a middle tube.

### DETAILED DESCRIPTION

Although certain example methods and apparatuses have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art

The vibration damper according to the present disclosure, in particular a multi-tube damper, has the advantage over conventional vibration dampers that the damper can be designed in a length-optimised form.

The middle tube according to the present disclosure has the advantage over conventional middle tubes that it can be assembled from simple components and/or a combination of different materials. Furthermore, a cost-optimised design is made possible.

In some examples, a vibration damper, in particular a multi-tube damper, for a vehicle, may comprise:
an outer tube, at least one middle tube and an inner tube which are arranged coaxially to one another, wherein an outer tube balancing chamber for receiving damping medium is formed between the outer tube and the at least one middle tube, and at least one middle tube balancing chamber for receiving damping medium is formed between the at least one middle tube and the inner tube, wherein
the at least one middle tube has at least one middle tube opening for fluidic through-connection of the outer tube balancing chamber to the middle tube balancing chamber, and the inner tube has at least one inner tube opening for fluidic through-connection of the middle tube balancing chamber to the inner chamber of the inner tube, wherein
the inner tube is at least partially filled with damping medium, wherein a piston rod is arranged in the inner tube so as to be movable to and fro, wherein a working piston arranged on the piston rod is movable with the piston rod, wherein the inner chamber of the inner tube is divided by the working piston into a rod-side working chamber and a rod-remote working chamber,
wherein at least one connecting element is arranged between the inner tube and the at least one middle tube on each side of the middle tube opening facing the tube ends of the at least one middle tube, and the at least one connecting element comprises at least one radially circumferential sealing element which seals the at least one middle tube balancing chamber against the outer tube balancing chamber at least with respect to the damping medium.

The present disclosure also concerns a middle tube for a vibration damper, in particular a multi-tube damper. The middle tube may have a middle tube opening and at least one connecting element is arranged on each side of the middle tube opening facing the tube ends of the middle tube, and the at least one connecting element comprises at least one radially circumferential sealing element. Of course one having ordinary skill in the art will appreciate that the middle tube may be utilized in the manufacture of a vibration damper, in particular a multi-tube vibration damper.

The present disclosure may be embodied both in a vibration damper, in particular a multi-tube damper, and also in the use of a middle tube for producing a vibration damper, in particular a multi-tube vibration damper.

In the context of the present disclosure, a connecting element means an element on which a sealing element is arranged such that the sealing element seals the middle tube balancing chamber against the outer tube balancing chamber at least with respect to a damping medium. For example, the connecting element may be geometrically configured such that the sealing element is received at least by form fit. In particular, the connecting element may either be an element which is arranged on a damper tube, such as e.g. the inner tube and/or middle tube, or is formed from the damper tube itself, such as e.g. by (re)forming machining (processes) of the damper tube, in particular by roll-forming of or in the region of a damper tube end. If the connecting element is formed for example from the damper tube itself, a region of the damper tube is deliberately brought into a different shape without removing or adding material in this region.

A sealing element in the context of the present disclosure means an element which is sealed with respect to a damping medium, in particular is impermeable to the damping medium. A sealing element according to the present disclosure is selected for example from a group of flat seals, profile seals, sleeve seals, sealing compounds, sealing rings, in particular O-rings, rubber sealing rings, vulcanised rubber sealing rings, polymer sealing rings or a combination thereof.

According to a preferred embodiment of the present disclosure, the at least one middle tube has a shorter tube length than the inner tube.

In a preferred embodiment of the present disclosure, the outer tube balancing chamber and/or the middle tube balancing chamber are/is arranged concentrically with respect to the inner tube.

According to a preferred embodiment of the present disclosure, the at least one connecting element is arranged on at least one tube end of the at least one middle tube.

According to a preferred embodiment of the present disclosure, the at least one connecting element has an at least form-fit connection to the comprised radially circumferential sealing element, in particular at least one connecting element has a recess which at least partially receives the radially circumferential sealing element.

In a preferred embodiment of the present disclosure, the at least one connecting element has a connection to the middle tube, wherein the radially circumferential sealing element lies against the inner tube.

According to a preferred embodiment of the present disclosure, the connection of the at least one connecting element is selected from a group of a form-fit connection, in particular a catch connection, a groove, a roll-over, a bead, a middle tube end flange; a force-fit connection, in particular a clamp connection; a substance-bonded connection, in particular a weld connection, a friction weld connection, an adhesive connection, or a combination thereof.

According to a preferred embodiment of the present disclosure, at least one tube end of the at least one middle tube is configured as at least one connecting element, wherein the tube end of the at least one middle tube is a flange ending in the direction of the inner tube.

In a preferred embodiment of the present disclosure, an at least partially radially circumferential bead extending in the direction of the inner tube is arranged spaced from the flange, wherein the radially circumferential sealing element is arranged in the region between the flange and the bead and lies against the inner tube.

According to a preferred embodiment of the present disclosure, the at least one connecting element has a connection to the inner tube, wherein the radially circumferential sealing element lies against the middle tube.

According to a preferred embodiment of the present disclosure, the connection of the at least one connecting element is selected from a group of a form-fit connection, in particular a catch connection, a groove, a roll-over, a bead; a force-fit connection, in particular a clamp connection; a substance-bonded connection, in particular a weld connection, a friction weld connection, an adhesive connection, or a combination thereof.

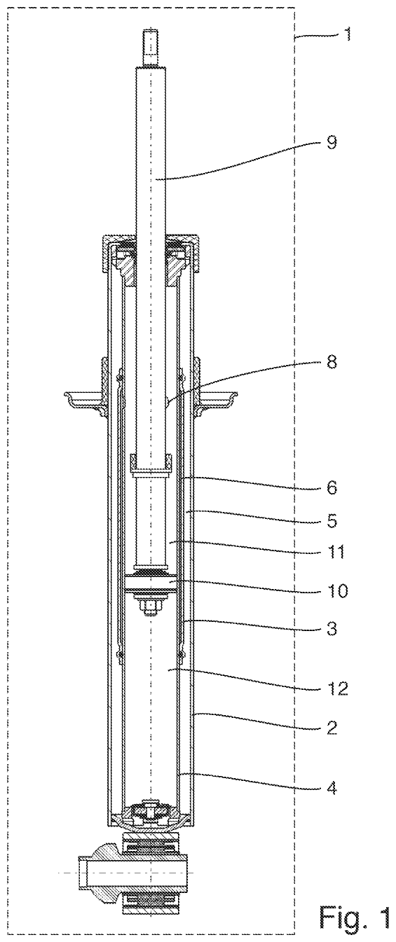

FIG. 1 shows a vibration damper 1 according to the present disclosure as a three-tube damper with an outer tube 2, a middle tube 3 and an inner tube 4. An outer tube balancing chamber 5 is arranged in the region between the outer tube 2 and the middle tube 3, and a middle tube balancing chamber 6 is arranged in the region between the middle tube 3 and the inner tube 4. A piston rod 9 is arranged in the inner tube 4 so as to be movable to and fro, wherein a working piston 10 arranged on the piston rod 9 is movable with the piston rod 9, wherein the inner chamber of the inner tube 4 is divided by the working piston 10 into a rod-side working chamber 11 and a rod-remote working chamber 12. The middle tube 3 has a middle tube opening 7 for fluidic through-connection of the outer tube balancing chamber 5 to the concentric middle tube balancing chamber 6. The inner tube 4 has an inner tube opening 8 for fluidic through-connection of the middle tube balancing chamber 6 to the inner chamber of the inner tube 4.

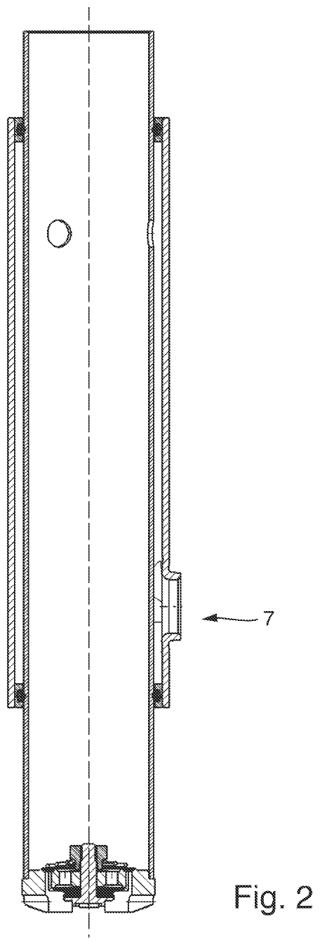

FIG. 2 shows an embodiment of the present disclosure according to FIG. 1 in the region of the damper tubes. In addition to the inner tube 4 with inner tube opening 8, and the middle tube 3 with middle tube opening 7, the drawing shows a connecting element 13 which comprises a sealing element 14.

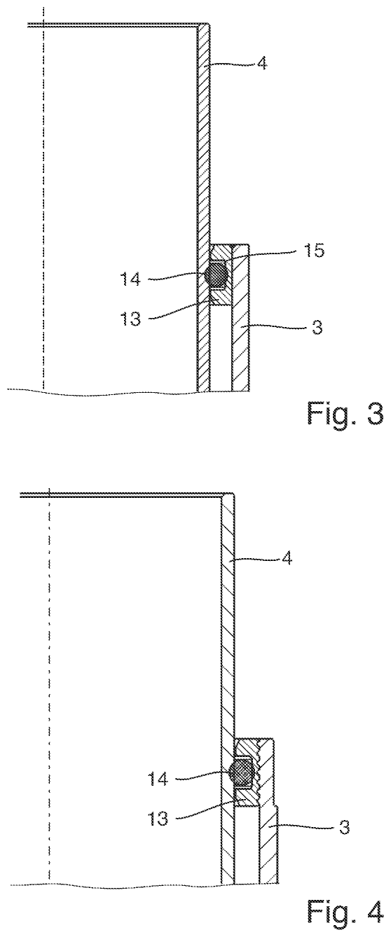

FIG. 3 shows an embodiment of the present disclosure according to FIG. 1 and/or FIG. 2 in the region of a seal of the inner tube 4 against the middle tube 3. The connecting element 13 is arranged by substance bonding on the middle tube 3 and receives the sealing element 14 in the U-shaped recess, wherein the sealing element 14 lies tightly against the outer wall of the inner tube 4.

FIG. 4 shows an embodiment of the present disclosure according to FIG. 1 and/or FIG. 2 in the region of a seal of the inner tube 4 against the middle tube 3. The connecting element 13 is arranged by form fit on the middle tube 3 and receives the sealing element 14 in the U-shaped recess, wherein the sealing element 14 lies tightly against the outer wall of the inner tube 4.

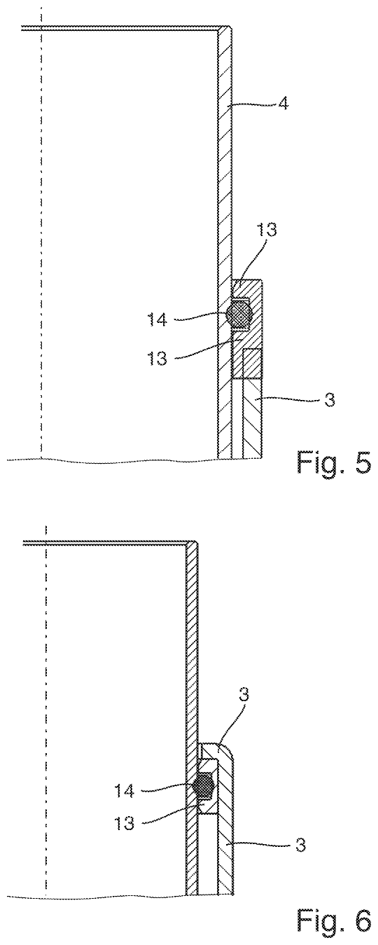

FIG. 5 shows an embodiment of the present disclosure according to FIG. 1 and/or FIG. 2 in the region of a seal of the inner tube 4 against the middle tube 3. The connecting element 13 is arranged by substance bonding on the middle tube 3 and receives the sealing element 14 in the U-shaped recess, wherein the sealing element 14 lies tightly against the outer wall of the inner tube 4.

FIG. 6 shows an embodiment of the present disclosure according to FIG. 1 and/or FIG. 2 in the region of a seal of the inner tube 4 against the middle tube 3. The middle tube end of the middle tube 3 has a roll-over in the direction of the inner tube 4, wherein the connecting element 13 is arranged by form fit on the roll-over, and the sealing element 14 arranged in the U-shaped recess of the connecting element 13 lies tightly against on the outer wall of the inner tube 4.

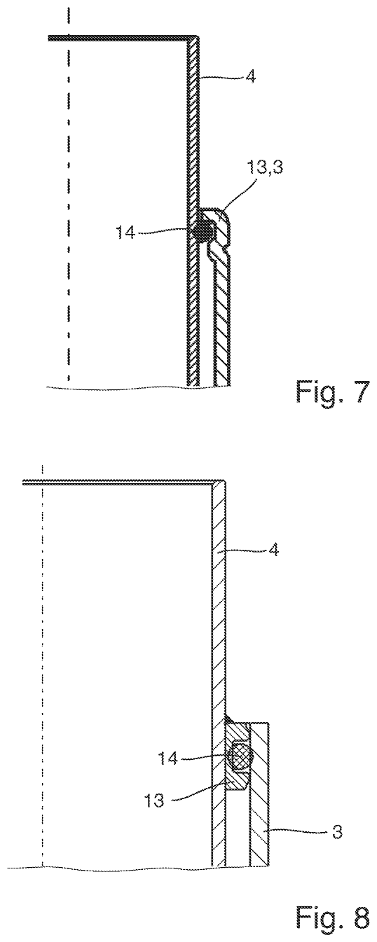

FIG. 7 shows an embodiment of the present disclosure according to FIG. 1 and/or FIG. 2 in the region of a seal of the inner tube 4 against the middle tube 3. At the end of the middle tube 3, as a connecting element 13, a U-shaped recess is provided which is formed from the middle tube 3, in particular by roll-over, wherein the sealing element 14 arranged in the connecting element 13 lies tightly against the outer wall of the inner tube 4.

FIG. 8 shows an embodiment of the present disclosure according to FIG. 1 and/or FIG. 2 in the region of a seal of the inner tube 4 against the middle tube 3. The connecting element 13 is arranged by substance bonding on the inner tube 4 and receives the sealing element 14 in the U-shaped recess, wherein the sealing element 14 lies tightly against the inner wall of the middle tube 3.

It will be understood that vibration dampers, in particular multi-tube dampers, and also middle tubes for a vibration damper of the type described above, are used in the production of vibration dampers.

### LIST OF REFERENCE NUMERALS

1=vibration damper

2=outer tube

3=middle tube

4=inner tube

5=outer tube balancing chamber

6=middle tube balancing chamber

7=middle tube opening

8=inner tube opening

9=piston rod

10=working piston

11=rod-side working chamber

12=rod-remote working chamber

13=connecting element

14=sealing element

What is claimed is:

1. A multi-tube vibration damper for a vehicle, comprising:
an outer tube, a middle tube, and an inner tube that are arranged coaxially;
a piston rod arranged in the inner tube so as to be movable to and fro;
a working piston arranged on and movable with the piston rod;
an outer tube balancing chamber for receiving damping medium formed between the outer tube and the middle tube;
a middle tube balancing chamber for receiving damping medium formed between the middle tube and the inner tube; and
a connecting element disposed between the inner tube and the middle tube,
wherein the middle tube includes a middle tube opening for fluidic through-connection of the outer tube balancing chamber to the middle tube balancing chamber,
wherein the inner tube includes an inner tube opening for fluidic through-connection of the middle tube balancing chamber to an inner chamber of the inner tube, wherein the inner tube is at least partially filled with damping medium, wherein the inner chamber of the inner tube is divided by the working piston into a rod-side working chamber and a rod-remote working chamber,
wherein the connecting element is disposed between the inner tube and the middle tube on each side of the middle tube opening facing tube ends of the middle tube, the connecting element comprising a radially circumferential sealing element that seals the middle tube balancing chamber against the outer tube balancing chamber at least with respect to damping medium.

2. The multi-tube vibration damper of claim 1 wherein the middle tube has a shorter tube length than the inner tube.

3. The multi-tube vibration damper of claim 1 wherein at least one of the outer tube balancing chamber or the middle tube balancing chamber is arranged concentrically with respect to the inner tube.

4. The multi-tube vibration damper of claim 1 wherein the connecting element is disposed on one of the tube ends of the middle tube.

5. The multi-tube vibration damper of claim 1 wherein the connecting element is form-fit connected to the radially circumferential sealing element.

6. The multi-tube vibration damper of claim 1 wherein the connecting element has a recess that at least partially receives the radially circumferential sealing element.

7. The multi-tube vibration damper of claim 1 wherein the connecting element has a connection to the middle tube, wherein the radially circumferential sealing element lies against the inner tube.

8. The multi-tube vibration damper of claim 7 wherein the connection of the connecting element is at least one of:
a form-fit connection configured as a catch connection, a groove, a roll-over, a bead, or a middle tube end flange;
a force-fit connection configured as a clamp connection; or
a substance-bonded connection configured as a weld connection, a friction weld connection, or an adhesive connection.

9. The multi-tube vibration damper of claim 1 wherein at least one of the tube ends of the middle tube is configured as the connecting element, wherein the at least one of the tube ends is a flange ending in a direction of the inner tube.

10. The multi-tube vibration damper of claim 9 wherein an at least partially radially circumferential bead extending in the direction of the inner tube is spaced apart from the flange, wherein the radially circumferential sealing element is disposed in a region between the flange and the at least partially radially circumferential bead and lies against the inner tube.

11. The multi-tube vibration damper of claim 1 wherein the connecting element has a connection to the inner tube, wherein the radially circumferential sealing element lies against the middle tube.

12. The multi-tube vibration damper of claim 11 wherein the connection of the connecting element is at least one of:
a form-fit connection configured as a catch connection, a groove, a roll-over, a bead;
a force-fit connection configured as a clamp connection; or
a substance-bonded connection configured as a weld connection, a friction weld connection, or an adhesive connection.

13. A middle tube for a vibration damper, wherein the middle tube has a middle tube opening and a connecting element that is disposed on each side of the middle tube opening facing tube ends of the middle tube, wherein the connecting element comprises at least one radially circumferential sealing element.

14. A method of producing a vibration damper, the method comprising providing the multi-tube vibration damper of claim 1.
